(19) United States
(12) Patent Application Publication
(10) Pub. No.: US 2013/0275755 A1
(43) Pub. Date: Oct. 17, 2013

(54) SYSTEMS, METHODS AND APPARATUSES FOR THE SECURE TRANSMISSION OF MEDIA CONTENT

(71) Applicant: Sergey IGNATCHENKO, Innsbruck (AT)

(72) Inventor: Sergey IGNATCHENKO, Innsbruck (AT)

(21) Appl. No.: 13/861,078

(22) Filed: Apr. 11, 2013

Related U.S. Application Data
(60) Provisional application No. 61/623,340, filed on Apr. 12, 2012.

(51) Int. Cl. H04L 29/06

(52) U.S. Cl. CPC H04L 63/0428
USPC 713/168

(57) ABSTRACT

The systems, methods and apparatuses described herein permit encrypted media content to be processed by a plurality of media processing blocks before being displayed on a screen. An apparatus according to the present disclosure may comprise a communication interface to receive an encrypted, encoded media stream, a first and second media processing blocks, and a screen for displaying decoded media stream. The first media processing block may decrypt the encrypted, encoded media stream to obtain the encoded media stream using a first key, decode the encoded media stream and encrypt the decoded media stream using a second key before transmitting it to the second media processing block. The second media processing block may decrypt the media stream using the second key and process the media stream using a screen controller before transmitting the media stream to the screen.

### RELATED APPLICATIONS

This application claims priority to U.S. Provisional Applications 61/623,340 filed Apr. 12, 2012, entitled “Systems, Methods and Apparatuses for the Secure Transmission of Media Content,” the content of which is incorporated by reference herein in its entirety.

### FIELD OF THE DISCLOSURE

The systems, methods and apparatuses described herein relate to the improved protection of digital media content and the field of digital rights management.

### BACKGROUND

The problem of media content misuse and digital rights management (DRM) is both well-known and significant. At the present time, there is no reliable way to provide both video and audio content to end-users while simultaneously preventing them from making unauthorized, digital copies of the media or otherwise circumventing DRM controls. To make things worse, digital copies of the media can often be produced without any loss in quality. Systems, methods and apparatuses have been suggested for precluding software-based methods of content duplication by end-users, which is the most widespread form of media content piracy. However, even those mechanisms may be vulnerable to hardware-based attacks. What is needed are systems, methods and apparatuses for precluding hardware-based methods of media content misuse having a minimal impact on the existing architecture of television sets and other media content playback devices.

### BRIEF DESCRIPTION OF THE DRAWINGS

FIG. 1 is a block diagram of an exemplary system according to the present disclosure.

FIGS. 2-5 show flow diagrams of exemplary methods of preparing and transmitting media content according to the present disclosure.

FIGS. 6-7 are block diagrams of additional exemplary systems according to the present disclosure.

FIGS. 8-10 show flow diagrams of additional exemplary methods of preparing and transmitting media content according to the present disclosure.

FIG. 11 is a block diagram of another exemplary system according to the present disclosure.

FIG. 12 is a block diagram illustrating the “chaining” of blocks.

### DETAILED DESCRIPTION

Certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

The present disclosure comprises systems, methods and apparatuses for the secure transmission of media content from any type of media distribution outlet capable of electronically providing digital media content (e.g., an internet store, a television broadcast facility, a radio broadcast facility, etc.), to a local device (e.g., a smartphone, desktop computer, laptop, set-top box, etc.), running an operating system and possibly one or more applications, and then from the local device to a display device (e.g., a television set, monitor, etc.), for presentation on the device (e.g., on a screen, speakers, or both). In another embodiment, media content may be transmitted directly from the media distribution outlet to a combined local device/display device for presentation on the device. For example, a laptop might function both as the local device and the display device. Secure transmission of the media content from the media distribution outlet to the display device, whether via a local device or not, may be accomplished through a combination of symmetric and public-private key cryptography.

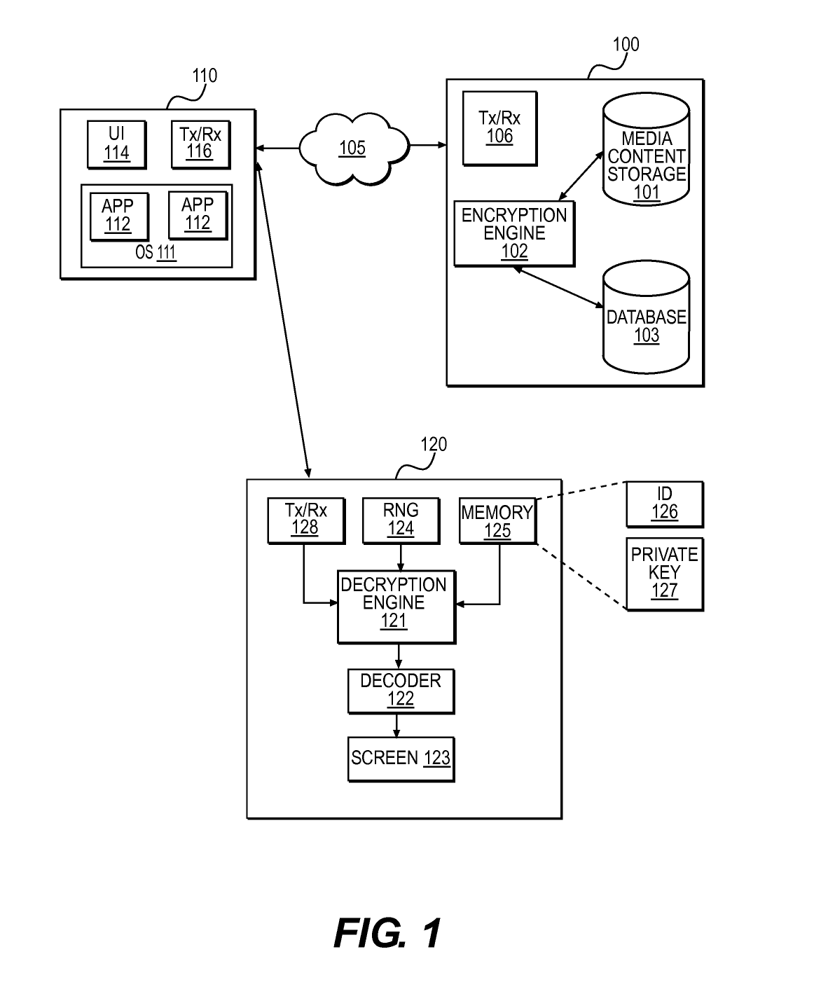

FIG. 1 shows a block diagram of an exemplary system according to the present disclosure. The system first comprises one or more display devices 120. Each display device 120 may possess a decryption engine 121 capable of performing at least symmetric and asymmetric decryption. For example, in one embodiment, the decryption engine 121 may implement RSA-2048 for public/private cryptography, and AES-256 for symmetric cryptography. Depending on the overall system needs, other ciphers alternatively may be used. As described in greater detail below, this functionality will allow the decryption engine 121 to a) decrypt a symmetric key previously encrypted with a public key associated with the device 120, and b) to decrypt media content data previously encrypted with the symmetric key. The keys used to support this decryption may be stored in a non-volatile memory 125, such as a non-volatile Flash memory. In one embodiment, the display device 120 may further comprise a hardware-based random number generator (RNG) 124 (such as, for example, a thermal-noise based or Zener noise-based generator) which can be used in support of the decryption engine 121.

Each display device 120 may further comprise a decoder 122 capable of decoding media content. “Media content” as used throughout refers to any visual data and/or audio data, such as, but not limited to, still images, pictures or graphics, text, movies, video clips, audio clips, two-dimensional animation, web pages, video games, three-dimensional images or video (including three-dimensional animation), or any combination of the foregoing. As such, the decoder 122 may be configured to decode media content in a variety of formats such as PNG, JPEG, H.264 AVC, MPEG-2, and/or VC-1. In addition, the decoder 122 may support decoding of audio formats. Depending on the embodiment, the decryption engine 121 and the decoder 122 may be implemented as software running on a processor (not shown) of the display device 120. For example, if the display device 120 includes a microcontroller unit (MCU) (not shown), the decryption engine 121,the decoder 122, or both, may be implemented as software running on the MCU. It will be understood, however, that these units may also be implemented in hardware, or in a hybrid software/hardware solution.

In some embodiments the display device 120 may include additional components and functionality. For example, in some embodiments the data signal from the decoder 122 may be forwarded to a video post processing unit (not shown), the purpose of which is to improve the overall video quality and/or adapt the signal according to the needs of specific implementation of screen 123 before it is transmitted to a screen 123 for display.

As shown on FIG. 1, the system may further comprise a local device 110 which may be, for example, a desktop computer, laptop, set-top box, etc. The local device 110 may comprise a user interface 114, an operating system 111, and one or more applications 112 (though it will be understood that there may be any number of applications or none at all) running under the operating system 111. In the discussion that follows, certain functionalities or capabilities of the local device 110 may be described as being performed by or encompassed within the operating system 111 or within an application program 112. It is to be understood that these exemplary embodiments are not intended to limit the scope of the present disclosure. Any functionality or capability of the local device may be performed by or embodied in any combination of the operating system 111, application program(s) 112, and/or specialized hardware.

Media content may be stored within the data storage 101 of a media distribution outlet 100, such as an Internet store, a television broadcast facility, a radio broadcast facility, a cable television head-end, etc. One having ordinary skill in the art will understand that such a media distribution outlet 100 could be implemented, for example, using a group of servers connected to a communications network 105 (e.g., the Internet). In certain embodiments, the media distribution outlet 100 may further comprise an encryption engine 102 capable of a) generating symmetric keys, b) performing symmetric encryption, and/or c) performing asymmetric encryption. The media encryption engine (either alone or in conjunction with other computer(s), server(s) and/or component(s) (not shown) comprising the media distribution outlet 100) may also be capable of creating fully or partially encrypted media content containers as described later herein. Like the decryption engine 121 of the display device 120, the encryption engine 102 of the media distribution outlet 100 may support any number of cryptographic algorithms, such as RSA-2048 and AES-256. The media distribution outlet 100 may further comprise a database 103 capable of storing display devices' 120 unique IDs and public keys (if database 103 is relational, this could be represented, by way of example, as (TV ID, TV public key) rows), as well as generated symmetric keys, and information about media content that a user has already purchased.

Each of the media distribution outlet 100, local device 110 and display device 120 may further comprise one or more communications ports 106, 116 and 128, respectively, by which each of these devices may transmit and/or receive media content, identifying information, and other information. The one or more communication ports 106, 116 and 128 may comprise any combination of hardware and/or software appropriate for establishing and maintaining two-way communications in an area (such as LAN, WAN or MAN), Internet, cellular, data, mobile or other appropriate network using any combination of wired (e.g., serial, parallel, Ethernet, and/or USB) and/or wireless (e.g., Bluetooth, near field communications, infrared, various flavors of IEEE 802.11, GSM, CDMA) technology, and/or custom connectors/protocols. It is to be understood, however, that these references are merely exemplary, and the invention is not limited to any specific form of communications technology.

To strengthen security throughout the entire process, the display device 120 itself preferably should have no capability to release unencrypted content in any form (except for showing it on screen 123). For example, allowing a TV set to have unencrypted HDMI output from an encrypted stream may weaken the security of the systems and methods provided herein. It should be recognized, however, that in some implementations such an unencrypted output may be included in the display device 120 for business considerations rather than technical or security considerations without departing from the scope of the present disclosure.

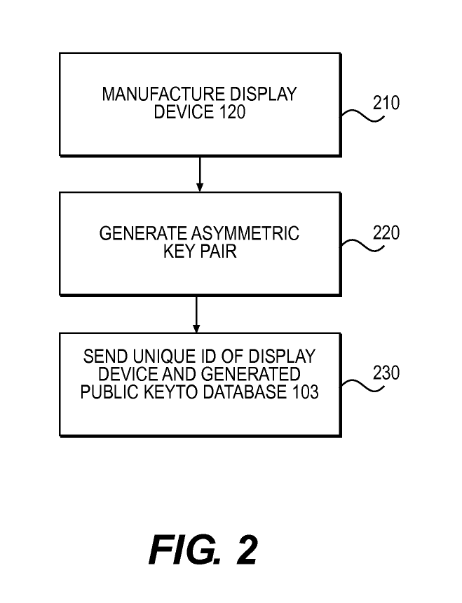

FIG. 2 shows an exemplary manufacturing process for a display device 120. At step 210, a display device 120 may be manufactured and a unique ID 126 (e.g., a serial number) may be assigned to and stored within the device 120. At step 220, a public/private key pair may be generated and assigned to the device 120 using, for example, the RNG 124. The private key 127 may be stored within the non-volatile memory 125 on the device 120, such that it cannot be extracted from the device 120 or otherwise compromised (for example, the memory 125 may be tamper-resistant and/or provide for tamper detection coupled with key erasure upon detection of any attempted tampering). The public key, on the other hand, may be retrieved from, or transmitted externally by, the display device 120. In other embodiments, the public/private key pair can be generated externally, and the private key 127 can be transferred into the display device 120. Regardless of how the key pair is generated, to enhance security, the display device 120 should not be capable of transmitting or otherwise revealing the private key 127.

At step 230, the device's unique ID 126 and public key may be provided to the media distribution outlet 100 for future use. For example, the manufacturer of the display device 120 may periodically send the unique ID and public key information of the devices it manufactures to the media distribution outlet 100. It may be desirable to restrict access to the manufacturing facility, so as to ensure that only “good” public keys (i.e., keys from actually-manufactured display devices, not just fake key sets generated maliciously) are delivered to the media distribution outlet 100.

In one embodiment, device IDs and public keys may be stored in the database 103 of a media distribution outlet 100 for future use. That said, it will be understood that there may be numerous distribution outlets capable of interacting with display devices 120. Therefore, the display device 120 manufacturer may send this information to all or a subset of known outlets 100, or, for example, to a centralized database which may be accessible by all or a subset of known distribution outlets 100. In another embodiment, the encryption engine 102 and/or the database 103 may be physically and/or logically separated from the media distribution outlet 100 and its associated media content stored in media content storage 101. For example, a centralized entity may possess device IDs and public keys, such that individual media distribution outlets 100 may contact this entity to obtain access to device IDs and public keys. In this manner, media content sellers/distributors themselves would not need to possess the information (and update it as new devices are manufactured), but could simply access the centralized entity. In some embodiments this entity could also be responsible for performing some or all of the necessary encryption and could then pass encrypted data back to the media distribution outlet 100 for further use and transmission.

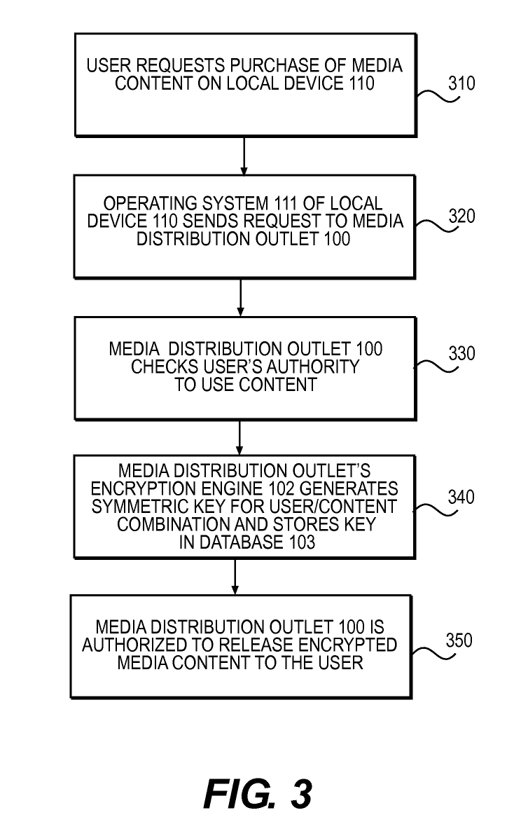

FIG. 3 shows an exemplary method by which a user may acquire rights to media content using a local device 110. At step 310, a user may request the purchase or rental of media content via the user interface 114. (This request may be explicit, or may implicitly result from a user request to download or playback media content.) The request may be generated within the operating system 111 or an application 112, and may include a unique user ID and a content ID. In certain embodiments the user ID may refer to a specific individual; in other embodiments, the user ID might refer simply to the local device 110 sending the request. The content ID may be used to refer to the media content the user has selected for purchase or rental.

At step 320, the operating system 111 may send the request to the media distribution outlet 100 via the communications port 116. In certain embodiments, all communications with media distribution outlet 100 may require user authentication (for example, by using a user ID/password combination), to be followed by use of an encrypted channel.

The media distribution outlet 100 may, at step 330, review the request and determine that the user is a registered user of the outlet 100 and that the user is authorized to view the content. For example, the outlet 100 may verify that the user has paid for the content (e.g., by using a credit card or by using an existing balance on the user account), or that the user is otherwise authorized to view the content (e.g., by presenting a promotional code or for some other reason). The outlet 100 could also verify that the user has appropriate privileges to view the content, e.g., parental control privileges. It will be understood that in embodiments in which only the local device 110 is identified by the user ID (as opposed to the actual user) the outlet 100 will only be able to verify payments, privileges and other information with relation to the local device 110, not the specific user. Therefore, in embodiments in which identifying the specific user is important (e.g., in a parental-control application), it may be desirable to authenticate individuals rather than just devices.

At step 340, the encryption engine 102 of the media distribution outlet 100 may generate one or more cryptographically-safe symmetric keys which may be stored in database 103 and associated with this user and this media content. For example, if database 103 is a relational database, this information can be stored as (user ID, content ID, symmetric key) rows.

At step 350, the media distribution outlet 100 may be permitted to release the media content to the user via its communications port 106, provided that the content has been encrypted with the symmetric key(s) which can be found in database 103 as associated with this user and this content. For example, the user might be allowed to download the encrypted media content to his local device 110. If multiple symmetric keys have been used to encrypt the content, all of those symmetric keys (and to the extent necessary, any information describing which keys apply to which portion of the content) can be stored in database 103. It will be noted that it is not a requirement of the system that a new key be generated for each user/content combination. However, the reuse of keys for different users and/or different content requested by the same user may reduce the overall system security (for example, by opening additional possibilities for differential cryptanalysis). Thus, it may be preferable to generate a new, unique key for each user/content combination.

In order to decrypt media content released, e.g., as according to step 350, the user must have some way of acquiring the symmetric key or keys used to encrypt the content. One method according to the present disclosure solves this problem by requiring the user to associate his purchased content with a specific display device 120. Once the content is associated with a specific display device 120, the symmetric key can be securely transferred to that display device 120 using the exemplary methods described herein.

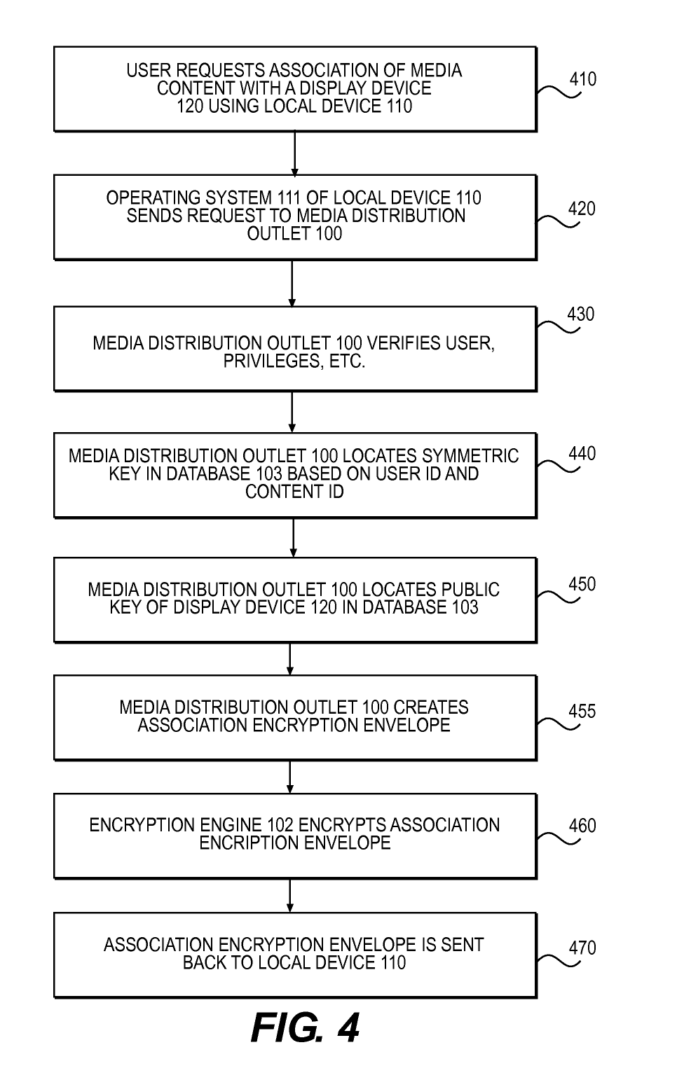

FIG. 4 shows one such method of associating purchased content with a specific display device 120. At step 410, the user may interact with his local device 110 (via the user interface 114) to request the association of purchased content with a specific display device 120. (This content may already have been downloaded to the local device 110, may be in the process of downloading to the local device 110, or may require downloading to the local device 110.) The local device 110 may already possess in its memory the unique ID 126 of the display device 120 which is to be associated with the purchased content, or it may communicate via its communication port 116 with the display device 120 in order to receive the display device's unique ID 126. At step 420, the operating system 111 may send an association request, comprising the unique ID 126 of the display device 120, the content ID and the user ID, to the media distribution outlet 100.

At step 430, the media distribution outlet 100 may receive the association request (generated at, e.g., step 420) and may check a) that the user is authorized to view the requested content (by, for example, detecting the presence of a symmetric key within database 103 for that specific user ID/content ID combination), b) that an allowed number of associated display devices 120 has not been exceeded for this user ID/content ID, and/or c) that the display device 120 has been registered in database 103 (and hence has an associated public key). After the checks are performed the media distribution outlet 100 may add a new record in database 103 to indicate that the display device 120 has been associated with this user and content.

At step 440, the media distribution outlet 100 may take the symmetric key from database 103 for the specific user/content combination; at step 450 it may take the public key of the display device 120; and at step 455 it may create an “association encryption envelope.” In one embodiment this association encryption envelope may contain only the symmetric key found in step 440, but in other embodiments and implementations it may additionally contain other information. At step 460, the encryption engine 102 may encrypt the association encryption envelope with the public key of the display device 120, and at step 470 may send the association encryption envelope back to the operating system 111 of the local device 110.

It will, of course, be understood that in some embodiments the processes of purchase and association can be initiated by a single action of the user (for example, a “purchase and play” action or equivalent). In this case, the operating system 111 can initiate the processes of acquiring rights to content (e.g., FIG. 3) and association (e.g., FIG. 4) automatically, one immediately after the other, without user intervention. In some cases, such requests can be even combined together to avoid unnecessary round-trip times.

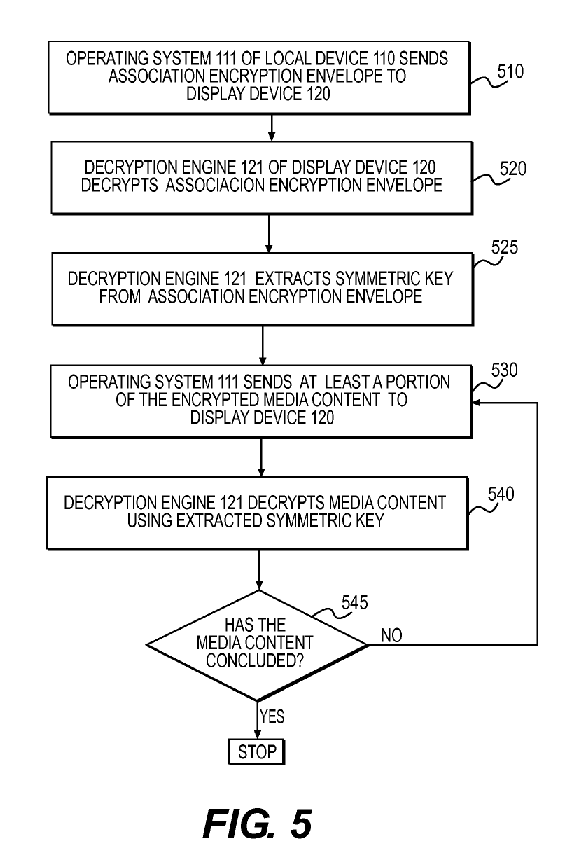

FIG. 5 shows an exemplary process for the playback of content acquired by the user, (e.g., in accordance with the acquisition process described with respect to FIG. 3), on a display device 120 which has been associated with the user and the content, e.g., in accordance with the association process described with respect to FIG. 4. Thus, it is assumed for the purpose of describing FIG. 5 that, before playback, the display device 120 has already received an association encryption envelope, encrypted using the public key corresponding to private key 127, and that this association encryption envelope contains at least a symmetric key which can be used to decrypt the acquired content.

At step 510, the operating system 111 may send the received association encryption envelope (still encrypted by the public key of the display device 120) to the display device 120. At step 520, the decryption engine 121 of the display device 120 may decrypt the association encryption envelope using the device's private key 127, and then at step 525 may extract the unencrypted symmetric key from the decrypted association encryption envelope.

At step 530, operating system 111 may begin transmitting at least a portion of the purchased content (such content still in an encrypted form, encrypted using the user/content-specific symmetric key) to the display device 120. As the display device 120 receives encrypted content, its decryption engine 121 may decrypt the content using the user/content symmetric key obtained at step 520. Then, the decrypted content may be decoded by decoder 122 and shown on screen 123. If, at step 545, there is still media content remaining (e.g., the entire movie has not been transmitted to the device 120), the method may return to step 530 to continue transmitting, decrypting and displaying content. If not, the method may stop.

The foregoing discussion has focused on systems and methods for securely transmitting media content among one or more media distribution outlets 100, one or more local devices 110, and one or more display devices 120, with the security solution designed primarily to thwart software-based attacks. While software-based attacks are often simple enough for an average computer user to implement, the inherent complexity of electronic hardware (e.g., of the internal connections) renders it less vulnerable to attack. Nevertheless, without additional effort to protect data within the display device 120—which is responsible for performing the final decryption and decoding of the media content (e.g., at step 530)—there still remain opportunities to maliciously access the media content.

For example, someone having a good understanding of electronics might use a probe to intercept the output of the decryption engine 121—i.e., the decrypted media content—as it is transmitted to the decoder 122. Similarly, a malicious user might use a probe to intercept the output of the decoder 122 as the decoded media content is being transmitted to the screen 123 for display.

Thus, certain embodiments according to the present disclosure are further designed to preclude various types of hardware-based attacks. In one such embodiment, the various components of the display device 120 may be implemented in one or more “monolithic blocks.” Each monolithic block, regardless of its internal structure or functionality, may be created such that it is difficult to disassemble, reverse engineer, and probe for internal signals.

For example, each monolithic block may use one or more existing or future-developed tamper-resistant technologies. Several tamper-resistant methods for protecting cryptographic processors are already known and have been described in the art; see [1]. In the present system, it may be desirable, for instance, to fabricate each monolithic block within a single chip. Each monolithic block may also use one or more existing or future-developed tamper-detection techniques; for example, each block might have a secure enclosure, and be configured to execute one or more possible responses if it detects penetration of that secure enclosure. These responses may vary from erasing any stored encryption key(s) within the monolithic block to the physical destruction of all or part of the monolithic block.

Such embodiments also may be designed to preclude the transmission of any signals containing pixel content (i.e., any type of image or video data) outside of these monolithic blocks unless those signals are either 1) analog signals (it being understood that analog-to-digital conversion is relatively difficult to perform in real time, and that significant quality loss is likely to be associated with such conversion), or 2) encrypted signals. In some embodiments, signals not containing pixel content, such as audio signals, could be left unencrypted and without any restrictions. In other embodiments, it may also be desirable to encrypt audio signals using the techniques described herein.

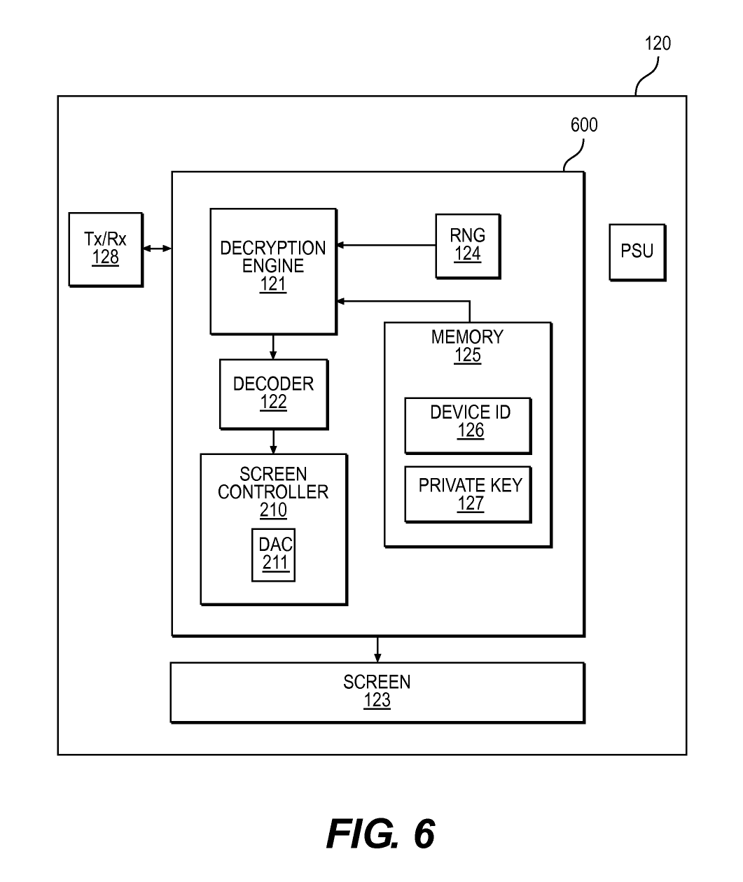

In one exemplary embodiment of a display device 120, as shown on FIG. 6, a single monolithic block 600 may be coupled to the communications port 128 and may comprise the decryption engine 121, the decoder 122, the RNG 124, the memory 125 (comprising the display device's unique ID 126 and private key 127) and a screen controller 210. A screen controller 210 may be any form of hardware or software suitable for receiving a decoded media file and processing it for playback on the screen 123 of the device, including but not limited to a “greyscale generator.” Depending on the specific implementation, the screen controller 210 may, in turn, contain one or more digital-to-analog converters (DAC) 211. As described in more detail above, this block 600 may incorporate tamper-resistant and/or tamper-detection techniques to enhance the overall security of the device 120.

Media content, whether encrypted or unencrypted, may be received by the communications port 128 and transferred to this monolithic block 600 for decryption (if necessary), decoding, and any other requisite processing.

Several additional, optional components, also might be included in a display device 120. For example, in liquid crystal display (LCD) television embodiments, components such as a tuner, a power supply unit (PSU), a microcontroller unit (MCU) and a video processing unit (VPU), or some combination thereof, might be included within the display device 120. As long as these optional components are not intended to work with media content transmitted securely from the media distribution outlet 100, it is generally preferable to place these components outside the monolithic block 600. For example, as shown on FIG. 6, a PSU may be placed outside of the monolithic block 600; in many cases, the MCU, the PCU, or both also could be placed outside of the monolithic block 600.

Use of a monolithic block 600 as described herein may provide excellent security against hardware-directed attacks. However, depending on how the block 600 is physically secured, it may require replacing the entire unit in the event of a single component's failure. For example, it would be difficult, if not impossible, to remove tamper-resistant protection from a monolithic block 600 in order to replace one of the components. Thus, in some embodiments, it may be desirable to separate some of the components over two or more monolithic blocks so as to allow for their easy replacement.

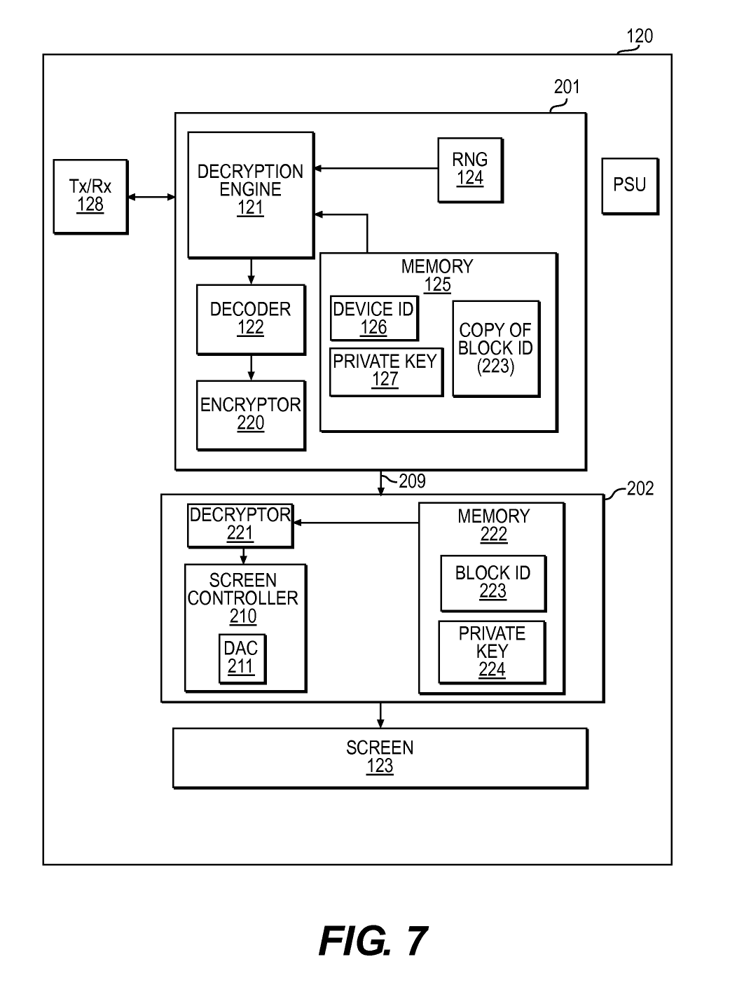

Accordingly, in another exemplary embodiment according to the present disclosure, as shown on FIG. 7, a display device 120 may comprise the communications port 128, the screen 123, and two monolithic blocks 201 and 202. A first monolithic “main” block 201 may be coupled to the communications port 128 and may comprise the decryption engine 121, the decoder 122, the RNG 124 and the memory 125 (comprising the display device's unique ID 126 and private key 127). Media content, whether encrypted or unencrypted, may be received by the communications port 128 and transferred to this main block 201 for decryption (if necessary) and decoding. A second monolithic “screen controller” block 202 may comprise, in part, screen controller hardware 210 and a memory 222.

It will be understood that in embodiments comprising one or more monolithic blocks, such as the embodiment shown on FIG. 7, a communications channel may be needed between the blocks. For example, as shown on FIG. 7, connection 209 may link the blocks 201 and 202, such that decoded digital media content (i.e., the output of the decoder 122) may be conveyed to the screen controller 211 for conversion into an analog signal suitable for display on the screen 123. This connection 209 may be one-way, i.e., only permitting data to be transmitted from the main block 201 to the screen controller block 202, or two-way, i.e., allowing data to be transmitted both to and from the screen controller block 202 to the main block 201. This connection 209 may be any appropriate form of wired or wireless connection between electronic components, such as, for example, low-voltage differential (LVD) or a computer bus (such as PCIe) connection. It is to be understood that the blocks 201, 202 may additionally comprise any transmitters and/or receivers (not shown) necessary to implement this communications channel.

The connection 209 may provide an opportunity for potential attacks and/or security breaches. For example, it may not be possible to securely protect the connection 209 from probes and/or eavesdropping by a malicious user. Thus, in some embodiments, in order to reduce the potential for attacks on this connection 209, all or a portion of the data transmitted across this connection 209 may be encrypted. In such embodiments, each of the monolithic blocks, 201 and 202, may further include encryption and/or decryption capabilities. For example, as shown on FIG. 7, the main block 201 may further comprise an encryptor 220, and the screen controller block 202 may correspondingly comprise a decryptor 221. A suitable encryptor 220 may take any form of hardware, software or a combination thereof configured to implement the encryption of digital media content and other related information, and that data may be encrypted using any suitable form of cryptographic algorithm (e.g., symmetric and/or asymmetric). The decryptor 221 may similarly be any form of hardware, software or combination thereof suitable for decrypting messages encrypted by the encryptor 220. In embodiments permitting two-way communications between the main block 201 and the screen controller block 202, both the encryptor 220 and the decryptor 221 may support both encryption and decryption.

In one exemplary embodiment according to the present disclosure, data transmitted over the connection 209 may be encrypted using the AES-128 symmetric algorithm (or other appropriate type of symmetric encryption). In this embodiment, the encryptor 220 and decryptor 221 may further implement the RSA-1024 asymmetric encryption algorithm (or other appropriate type of asymmetric encryption), which may be used, for example, to securely transfer an AES-128 symmetric key. In particular, in some such embodiments, the main block 201 may generate an AES-128 symmetric key (such as by using RNG 124, for example) and encrypt this symmetric key using the public key of the screen controller block 202. Various methods by which the main block 201 may receive such a public key of the screen controller block 202 are discussed in further detail below. Then, the encrypted symmetric key may be transmitted by the main block 201 to the screen controller block 202 via the connection 209, where the decryptor 221 may use its private key to decrypt the received symmetric key. The encryptor 220 and decryptor 221 may then proceed to use this symmetric key to encrypt any data transmitted across the channel 209. In some embodiments, it may be desirable for the main block 201 to periodically renegotiate this symmetric key to further improve the security of the channel 209. For example, it may be desirable to produce and exchange a new symmetric key every minute, or every five minutes, or every half-hour.

In other embodiments, it may be desirable to use the public key of the screen controller block 202 to encrypt all data across the connection 209, rather than negotiating one or more symmetric keys. However, it will be understood that this may cause, for example, performance issues, due to the significant computational burden of asymmetric algorithms.

In some implementations of this secured connection 209, it may be desirable to synchronize and/or re-synchronize one or more initialization vectors used by the encryptor 220 and the decryptor 221. This resynchronization may be especially important in cases in which the communication channel 209 is one-way, and no feedback or errors can be reported back from the screen controller block 202 to the main block 201. One possible method by which synchronization may be accomplished is to have the encryptor 220 (i) issue a synchronization command to the decryptor 221 containing an initialization vector appropriate for the symmetric encryption algorithm being used, and (ii) simultaneously re-initialize itself using the same initialization vector. For example, if the encryptor 220 and decryptor 221 are configured to implement the AES-128 cipher, the encryptor 220 may send the initialization command to the decryptor 221 along with a 128-bit initialization vector. The initialization vector may be created by RNG 124 or any other suitable mechanism.

It will be understood that other ways of synchronizing the encryptor 220 and decryptor 221 are possible, including the issuance of a synchronization command to the decryptor 221, which command does not contain the new initialization vector. In this embodiment, a predefined initialization vector may be stored within the screen controller block 202, such as within memory 222. Alternatively, a predefined initialization vector could be hardcoded into block 202, stored together with the public key corresponding to private key 224, in database 103, and sent within “association encryption envelope” to the main block 201; this way both the main block 201 and the screen controller block 202 will have the same initialization vectors.

Regardless of their specific implementation, synchronization commands may be sent to the decryptor 221 at various times as deemed necessary in light of the overall system properties and constraints. For example, synchronization commands might be sent each time the display device 120 is powered-on. In certain embodiments, it may further be desirable to re-synchronize the encryptor 220 and decryptor 221 at regular intervals, such as, for example, every second (for example, to account for the possible errors in the one-way data stream).

It will be understood that, in embodiments using two or more monolithic blocks (such as the example shown on FIG. 7) and a communications channel, it will be important for each main block 201 to have access to whatever key is necessary to encrypt communications intended for the screen controller block 202. For example, in embodiments using asymmetric encryption to negotiate a symmetric key, the main block 201 would need some mechanism for acquiring the public key which corresponds to the private key 224 of the screen controller block 202.

In some embodiments, this public key may be distributed at the time the components of display device 120 are manufactured. A manufacturing procedure, similar to that described with respect to FIG. 2, may be used to ensure that the public key of each block is transmitted to the media distribution outlet 100 and stored within the database 103. Thus, as a result of applying this procedure to the main block 201, both the device ID 126 and the public key corresponding to the private key 127 may be stored within the database 103. Similarly, as a result of applying this procedure to the screen controller block 202, the block ID 223 and the public key corresponding to the private key 224 may be stored within the database 103. When the display device 120 is assembled, a copy of the block ID 223 of the screen controller block 202 may be stored in the memory 125 of the corresponding main block 201, and then may be used in association requests, e.g., as described with respect to FIG. 3. This may be particularly useful in embodiments which have a one-way communications channel 209 and the block ID 223 of the screen controller block 202 would not otherwise be available to the main block 201. In other embodiments, in which the channel 209 is two-way, the main block 201 may be able to obtain the screen controller block's block ID 223 upon request.

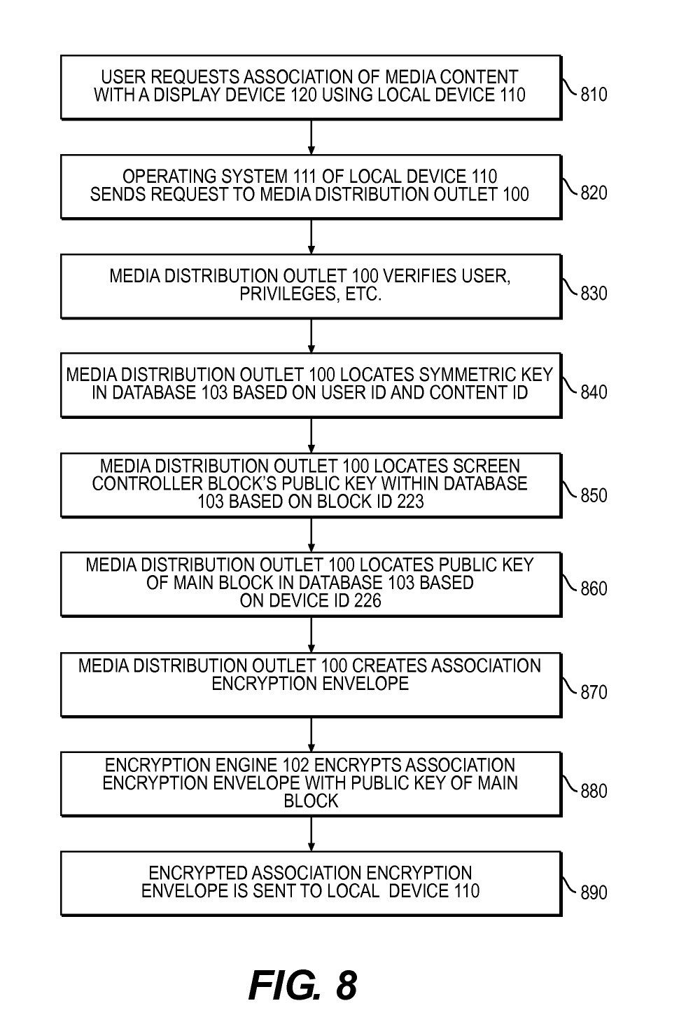

FIG. 8 shows an exemplary method of associating purchased content with a specific display device 120 having one or more monolithic blocks. This process is similar to that described above with respect to FIG. 4, with the addition of providing the screen controller block's public key (which corresponds to the private key 224) within the association encryption envelope. As shown on FIG. 8, at step 810, the user may interact with his local device 110 to request the association of purchased content with a specific display device 120. At step 820, the operating system 111 of the local device 120 may send an association request, comprising the unique ID 126 of the display device 120, the content ID and the user ID, to the media distribution outlet 100.

At step 830, the media distribution outlet 100 may receive the association request (generated at, e.g., step 820) and may verify that the user has the appropriate privileges to associate the selected content with the specific display device 120. After the checks are performed the media distribution outlet 100 may add a new record in database 103 to indicate that both the main block 201 and the screen controller block 202 have been associated with this user and content.

At steps 840-860, the media distribution outlet 100 may locate a number of items within database 103. At step 840, the media distribution outlet 100 may locate the symmetric key from database 103 for the specific user/content combination. At step 850, the media distribution outlet 100 may use the block ID 223 to locate within database 103 the public key associated with the appropriate screen controller block 202 (corresponding to private key 224). At step 860 the media distribution outlet 100 may use the device ID 126 to locate within database 103 the public key (which corresponds to private key 127) of the main block 201. Then, at step 870, the media distribution outlet 100 may create an association encryption envelope comprising both the symmetric key found in step 840 and the screen controller block's public key found at step 850, as well as any other desired information.

At step 880, the encryption engine 102 may encrypt the association encryption envelope with the public key of the main block 201 (found at step 860), and at step 890 may send the association encryption envelope back to the operating system 111 of the local device 110, which will forward it to the main block 201 of the display device 120. The main block 201 now has all of the encryption keys that may be required to play back media content.

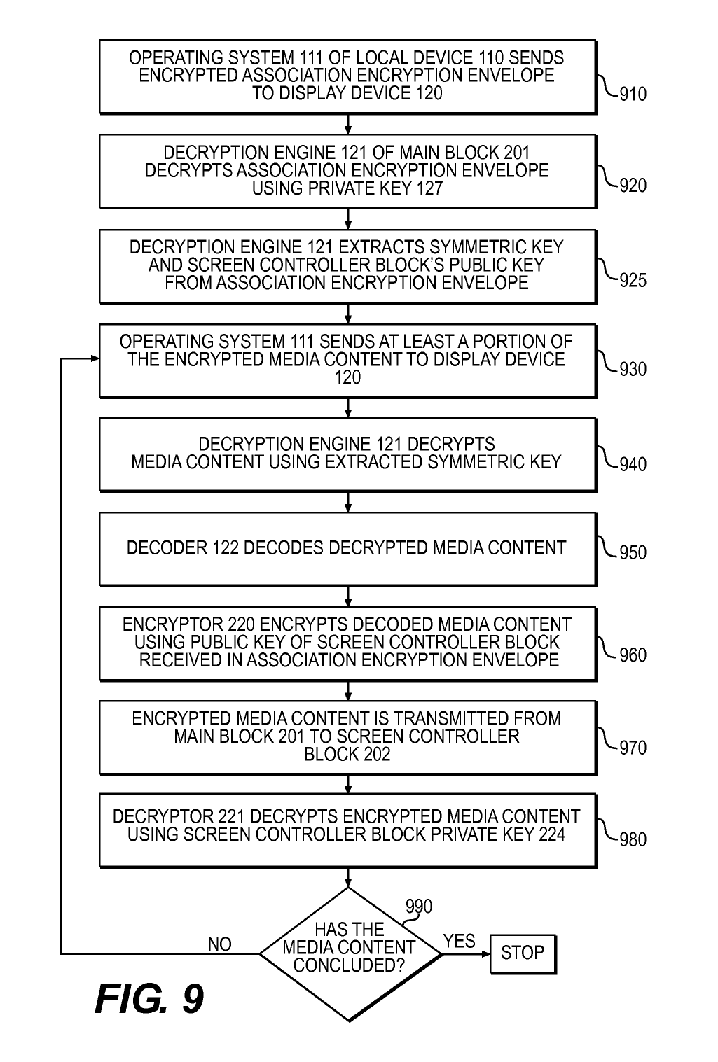

FIG. 9 illustrates how media content associated with a display device 120 having two or more monolithic blocks (e.g., as associated in accordance with the process described with respect to FIG. 8) may be played back on that device 120. This process expands on the process described with respect to FIG. 5, previously.

At step 910, the operating system 111 may send a received association encryption envelope (still encrypted by the public key of the main block 201) to the display device 120. At step 920, the decryption engine 121 of the display device 120 may decrypt the association encryption envelope using the device's private key 127, and at step 925 may extract both the symmetric key (used to encrypt media content) and the public key (associated with the screen controller block 202) from the decrypted association encryption envelope.

At step 930, the operating system 111 may transmit some or all of the purchased media content to the display device 120, where it is received by communications port 128 and provided (still encrypted) to the main block 201. As the main block 201 receives encrypted content, at step 940, the decryption engine 121 may decrypt the content using the user/content symmetric key obtained at step 920 and at step 950, the decoder 122 may decode the content.

One additional optional feature according to the present disclosure is to provide a (preferably invisible) digital watermark after, or in the process of, the decoding of media content performed at step 950. Such a watermark may be added, for example, while the decoder 122 performs any inverse discrete cosine transforms (inverse DCT), or similar transformations (for example, spatial block transforms in H.264) necessary for the decoding of compressed video content. This digital watermark may be used to identify the particular main block 201 which has decoded the media content. In one embodiment, this may be accomplished by using the device ID 126 during the process of generating the watermark. In another embodiment, the media distribution outlet 100 may add to the association encryption envelope a value based on the device ID 126 that may then be used during the process of watermark generation. This watermark may be created and added by, for example, by the decoder 122.

At step 960, the encryptor 220 may encrypt the decoded media content for secure transmission via the channel 209 to the screen controller block 202. In certain embodiments, as described in greater detail above, the encryptor 220 may encrypt the decoded media content using the public key of the screen controller block 202 received in the association encryption envelope. In other embodiments, also as described in greater detail above, the encryptor 220 and decryptor 221 may first negotiate one or more symmetric keys which can be used to encrypt the media content. Then, at step 970, this encrypted (but decoded) media content may be transmitted via the connection 209 to the screen controller block 202.

It may be that in certain embodiments, there are additional modules between the main block 201 and the screen controller block 202. For example, in some embodiments, there could be several screen controller blocks 202 and/or a multiplexor between the main block 201 and these various screen controller blocks 202. It will be understood, however, that there may not be a need for any additional encryption at these intermediate modules, as information leaving the main block 201 already will have been encrypted.

At step 980, the decryptor 221 may decrypt the media content using the appropriate key, e.g., a private key 224 or a symmetric key negotiated based on the private key 224, wherein the private key 224 may have been stored within memory 222. At this point, the decrypted, decoded media content may be processed by screen controller 210 (e.g., converted to an analog signal) and provided to screen 123 for display. If, at step 990, the media content has not concluded, the method may return to step 930 and continue to process additional portions of media content.

Optionally, as described previously with respect to the main block 201, the screen controller block 202 may add a watermark to the decrypted, decoded media content, specific to this particular screen controller block 202, before providing the media content to the screen 123 for display. Such a watermark may contain the block ID 223, a value derived from the block ID 223, or some other value provided in the association encryption envelope.

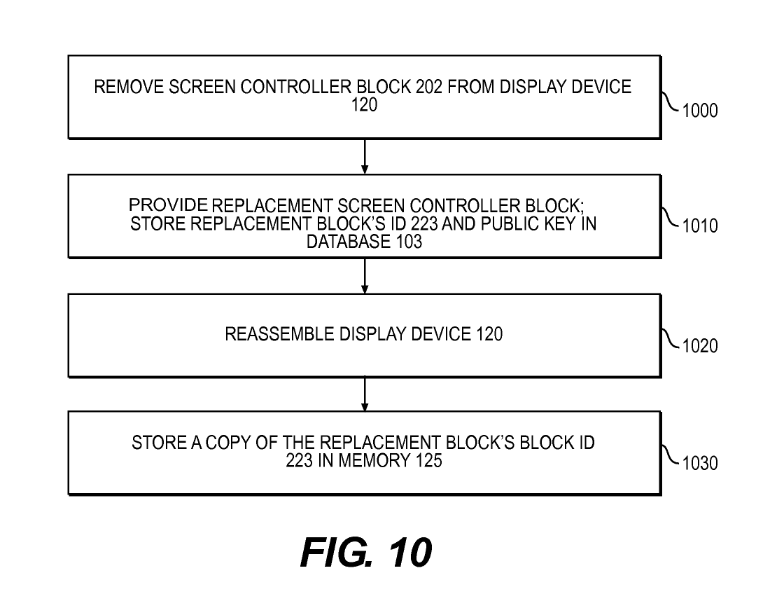

From time to time it may be desirable to replace one or more monolithic blocks within a display device 120. For example, one or more components within a block may fail, necessitating repair of the device 120. FIG. 10 shows an exemplary procedure by which blocks may be changed within a display device 120.

As shown on FIG. 10, at step 1000, the block to be replaced may be removed from the display device 120. For example, a faulty screen controller block 202 may be disconnected from the main block 201 and removed from the device 120.

At step 1010, a replacement screen controller block may be provided for insertion into the display device 120. During this step 1010, an asymmetric key pair may be generated and stored within the replacement screen controller block, of which the public key then may be transmitted (along with the block ID 223) to the database 103.

At step 1020, the display device 120 may be reassembled. This step 1020 may include, for example, physically connecting the main block 201 to the replacement screen controller block 202.

At step 1030, a copy of the block ID 223 may be stored in the memory 125 of the corresponding main block 201, and then may be used in association requests, e.g., as described with respect to FIG. 3. As noted previously, this may be particularly useful in embodiments which have a one-way communications channel 209 and the block ID 223 of the screen controller block 202 would not otherwise be available to the main block 201. In other embodiments, in which the channel 209 is two-way, the main block 201 may be able to obtain the screen controller block's block ID 223 upon request.

In one embodiment, this new information may replace any information stored for the old screen controller block in the database 103. In such an approach, any association requests, as described, e.g., with respect to FIG. 8, requested by the user after the replacement may associate the new public key (corresponding to private key 224) with media content. Additionally, association requests (but not encrypted media content itself) issued for the old screen controller block may become “invalid,” and may require reissuance with the new public key. This may be performed automatically, or may be performed on-demand whenever the user requests the playback of particular media content.

Although the foregoing description with respect to FIG. 10 has described the replacement of a screen controller block 202, it will be understood that the invention is not so limited and any type of monolithic block may be replaced in an analogous fashion. For example, a main block 201 might be replaced using a similar method, substituting the device ID 126 and the public key corresponding to private key 127.

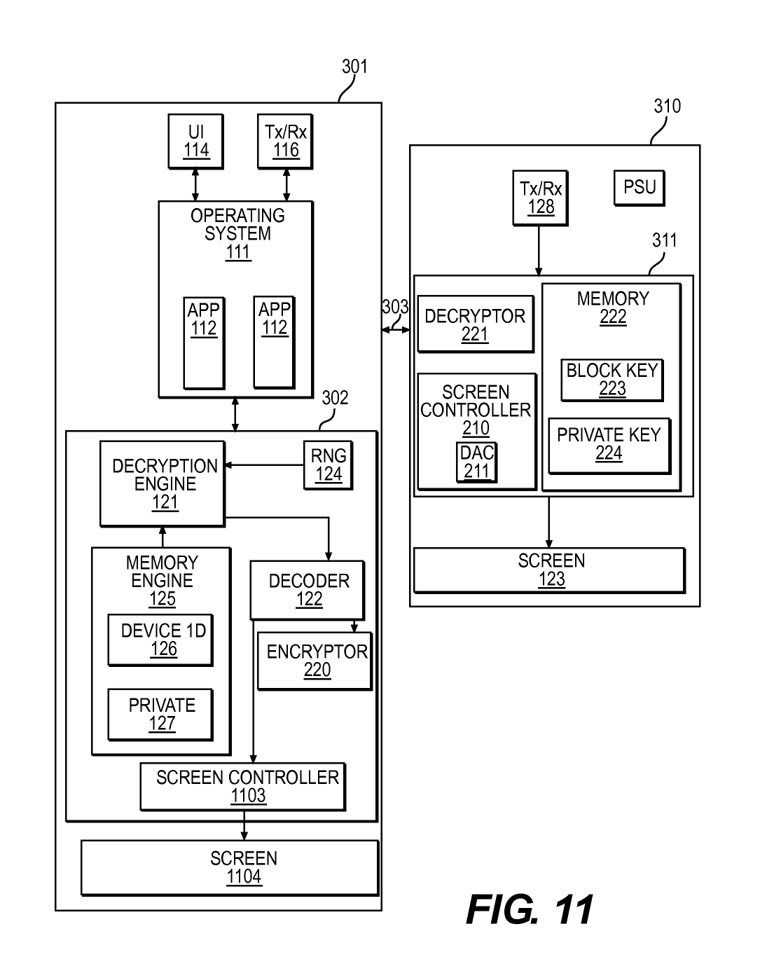

FIG. 11 shows yet another embodiment according to the present disclosure for systems in which some of the media content processing (and related components) is transferred from the display device to the local device. As depicted on FIG. 11, a local device 301 may comprise not only an operating system 111 (and possibly one or more applications 112), a user interface 114, and a communications port 116, but it may further comprise a “main block” 302, a screen controller 1103 and a screen 1104. For example, such a local device 301 may be a laptop, desktop computer, smart phone, personal digital assistant, tablet computer, Blu-Ray player, DVD player, personal music player, etc. In such an embodiment, encrypted media content may be received on the local device 301, decrypted and decoded within the secured main block 302, and played back on the screen 1104.

If it is desirable to play the content back on, for example, a larger screen, a simpler display device 310 (as compared to the display devices 120 discussed herein previously), as shown on FIG. 11, may be used. According to this embodiment, a display device 310 may only require a communications port 128 and a screen controller block 311. As was described in greater detail above, the screen controller block 311 may only comprise a decryptor 221, a screen controller 211, and a memory 222. This simpler display device 310 may not, however, require the potentially resource-intensive decryption engine 121 and decoder 122. Such a display device 310 might be, for example, a “simple” television.

In order to play back content on such a display device 310, the media content may be encrypted by the encryptor 220 (within the main block 302) and transmitted via the communications port 116 across a communications link 303. The encrypted content may be received by the communications port 128 of the display device 310 and provided to the decryptor 221 for decryption and subsequent processing.

As shown on FIG. 11, the main block 302 has essentially been moved into the local device 301. In such a case, as shown on FIG. 11 and like many of the embodiments already described herein, the device ID 126 may be stored within memory 125 of the main block 302 of the local device 301, and the block ID 223 may refer to the screen controller board 311 of the display device 310. Because the local device 301 may operate with a number of different display devices 310, in some embodiments, it may be desirable not to store a copy of the block ID 223 within the memory 125 of the local device 301, but rather to send a copy of this block ID 223 from each screen controller block 311 to the main block 302 over the connection 303. For example, the block ID 223 might be sent every time an association is established. Regardless of the specific implementation, values of both the device ID 126 and the block ID 223 may be provided to the media distribution outlet 100 as described in more detail above.

It will be understood that, because the media content leaving encryptor 220 is encrypted, it is possible for the communications channel 303 connecting the local device 301 and the display device 310 to be unsecured without compromising the security of the overall system. Thus, for example, the unsecured operating system 111 could control this communications link, allowing the main block 302 to make use of whatever communication facilities and other services are available within the operating system 111. By way of example only, in this embodiment, the operating system 111 could be used to establish a Wi-Fi connection to the “simple” television 310.

It shall be noted that, while the previous discussion focused on implementations using two monolithic blocks, the systems, methods and apparatuses disclosed herein may support any number of blocks, with decryption and re-encryption in all the blocks except for the last (i.e., the block responsible for converting the digital media content into an analog signal for display on the screen 123), and wherein the keys for all blocks, except for the key of the first block, are included in the association encryption envelope—essentially creating a “chaining” effect of blocks within the framework of present invention.

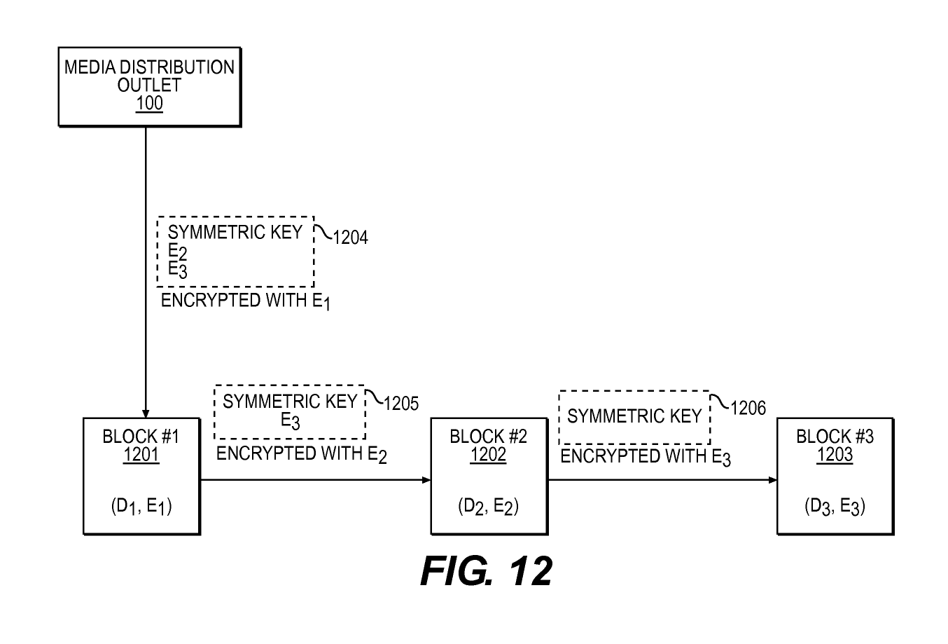

For example, FIG. 12 shows a logical diagram of an exemplary embodiment having three blocks. In such an embodiment, each block (1201, 1202 and 1203) may possess an asymmetric key pair represented as (D, E), wherein D signifies the private (or “decrypting”) key and E signifies the public (or “encrypting”) key. A first association encryption envelope 1204 provided by the media distribution outlet 100 may include the symmetric key associated with the media content (e.g., at step 340) and E₂ and E₃ (the public keys of blocks #2 and #3). This association encryption envelope 1204 may be encrypted with E₁ (the public key of block #1).

Then, block #1 (1201) might create a second association encryption envelope 1205, containing E₃ (the public key of block #3) and a symmetric key which may be used to encrypt the connection between block #1 (1201) and block #2 (1202). This symmetric key may be negotiated by the two blocks as described previously herein. This second association encryption envelope 1205 may be encrypted with E₂ (the public key of block #2) and transmitted to block #2 (1201). Block #2 (1202) may, in turn, negotiate a symmetric key with block #3 (1203), and encrypt this symmetric key with E₃ (the public key of block #3). Block #3, the end of the chain, may use the received symmetric key to decrypt the content in the manner similar to described above.

It will be understood that different encryption algorithms may be used for the different “links” of the “chain” if desired. For example, it may be desirable to use more secure algorithms for external connections between devices (e.g., from the local device 301 to the display device 120) than for internal connections (e.g., from the main board 201 to the screen controller board 202).

We note that the specific uses of symmetric and asymmetric encryption in the systems and methods described herein are but one possible embodiment. Depending on the overall system constraints and capabilities of the various apparatuses, it may be possible to substitute symmetric encryption for asymmetric encryption and vice versa. For example, the display device 120 might have its own secret symmetric key, rather than a public/private key pair. In this case, the database 103 of the media distribution outlet 100 would need to store the secret symmetric keys of display devices 120. While such an embodiment is within the scope of the present disclosure, care should be taken to ensure that the display device keys stored in the database 103 are not compromised, either while they are being transmitted to the database 103 or while stored in the database 103. Similarly, it will be understood that the term “public key” has been used throughout to refer to the encryption key to be used with the screen controller block 202, this key may be used for symmetric or asymmetric encryption as dictated by the overall system constraints. In the event that this public key is actually a symmetric key, care should be taken to ensure that this key is protected. Which specific combination of symmetric key or public/private key cryptography to use to implement a system according to the present disclosure is a matter of implementation choice governed by issues, such as, processing power available to perform encryption/decryption and the importance of speed in accomplishing encryption/decryption.

It should also be noted that whenever encryption of some content with an asymmetric key (i.e., a public or private) key is mentioned within present description, it can be either implemented as direct encryption with the asymmetric key, or, alternatively, by generating temporary crypto-safe symmetric key, encrypting content with this temporary symmetric key, and encrypting the temporary symmetric key with an asymmetric key. Then, the encrypted content will include both content encrypted with the temporary symmetric key, as well as the temporary symmetric key encrypted with the asymmetric key. This is a standard technique in cryptography used for optimization purposes, when, for example, it may not be desirable to encrypt large amounts of data using asymmetric encryption because of limited system resources (it being understood that asymmetric encryption is generally slower and more resource-intensive than symmetric encryption).

It will be understood that, though much of the previous discussion has focused on the secure transmission of video content, other types of content, such as, for instance, audio content, may be secured and transmitted in a similar way. For example, the main block 201 may be capable of decoding audio content, and an audio controller block, similar to the screen controller block 202, may be configured to convert an audio signal from a digital to analog format. This audio controller block may be coupled to one or more speakers. Such an embodiment may be used to prevent malicious users from copying audio content in its digital form.

It further will be understood that, though the present discussion has focused on communication with a single media distribution outlet 100, devices according to the present disclosure may interact with multiple different outlets. To expedite processing of user requests, the operating system 111 may remember from which media distribution outlet it has purchased certain content, and direct association requests for that content to the appropriate outlet 100.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, it will be understood that the block diagrams included herein are intended to show a selected subset of the components of each apparatus and system, and each pictured apparatus and system may include other components which are not shown on the drawings. Additionally, those with ordinary skill in the art will recognize that certain steps and functionalities described herein may be omitted or re-ordered without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application—such as by using any combination of microprocessors, microcontrollers, field programmable gate arrays (FPGAs), application specific integrated circuits (ASICs), and/or System on a Chip (SoC)—but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

What is claimed is:

1. An apparatus for receipt and play of encrypted media content, comprising:
a first communication interface configured to receive an encrypted, encoded media stream;
a first block comprising:
a first non-volatile storage storing therein a first key for encryption or decryption, the first block configured to prevent the first key being extracted from the apparatus;
a decryption engine configured to decrypt, using the first key, the encrypted, encoded media stream to obtain an encoded media stream;
a decoder configured to decode the encoded media stream to produce a first decoded media stream; and
an encryption engine configured to encrypt the decoded media stream to produce an encrypted, decoded media stream;
a second block comprising:
a second non-volatile storage storing therein a second key for encryption or decryption, the second block configured to prevent the second key being extracted from the apparatus;
a decryption engine to decrypt the encrypted, decoded media stream to produce a second decoded media stream; and
a screen controller;
a connection between the first block and the second block for, in part, transmitting the encrypted, decoded media stream from the first block to the second block; and
a screen for displaying the second decoded media stream.

2. The apparatus of claim 1, wherein the first block is a tamper-resistant block.

3. The apparatus of claim 1, wherein the second bock is a tamper-resistant block.

4. The apparatus of claim 1, wherein the first block is configured to:
receive a public key of the second block;
obtain a symmetric key;
encrypt the first decoded media stream using the symmetric key; and
encrypt the symmetric key using the public key of the second block.

5. The apparatus of claim 1, wherein the first and second blocks are a part of a plurality of media processing blocks of the apparatus, the plurality of media processing blocks are connected in a chain such that each first block of two adjacent blocks in the chain is configured to send the media stream in an encrypted format to a second block of the two adjacent blocks in the chain and a last block in the chain sends the media stream to the screen in a non-encrypted format.

6. The apparatus of claim 5, wherein each first block of two adjacent blocks in the chain is configured to receive a public key of the second block of the two adjacent blocks in the chain for encryption.

7. The apparatus of claim 5, wherein each of the plurality of media processing block is tamper-resistant.

8. A computer-implemented method for displaying encrypted media content on a display device, comprising:
at a first block:
receiving an encrypted, encoded media stream;
decrypting the encrypted, encoded media stream using a first key to extract an encoded media content;
decoding the encoded media stream to produce a first decoded media stream;
encrypting the first decoded media stream to produce an encrypted, decoded media stream;
transmitting the encrypted, decoded media stream to a second block; and
at a second block:
receiving the encrypted, decoded media stream;
decrypting the encrypted, decoded media stream to produce a second decoded media stream;
transmitting the second decoded media stream to a screen to display the second decoded media stream.

9. The method of claim 8, at the first block, further comprising:
receiving a public key of the second block;
obtaining a symmetric key; wherein encrypting the first decoded media stream comprises encryption using the symmetric key; and
encrypting the symmetric key using the public key of the second block.

10. The method of claim 8, wherein the first block is tamper-resistant.

11. The method of claim 8, wherein the second block is tamper resistant.

12. The method of claim 8, at the first block, further comprising:
creating an initialization vector; and
transmitting a synchronization command containing the initialization vector from to the second block.

13. A system for receipt and process of encrypted data, comprising:
a plurality of data processing blocks connected in a chain, wherein at least one of the plurality of data processing blocks further comprises;
a receiver to receive the encrypted data, a first encryption key used to encrypt the encrypted data, and a public key of a block next in the chain, wherein the first encryption key is encrypted using a public key of the at least one data processing block;
a decryption engine to decrypt, using a private key corresponding to the public key of the at least one data processing block, the first encryption key, and to decrypt the encrypted data using the decrypted first encryption key;
a processor to process the decrypted data;
an encryption engine to encrypt the processed data using a second encryption key, and to encrypt the second encryption key using the received public key of the block next in the chain;
a transmitter to transmit the encrypted processed data and the encrypted second encryption key to the block next in the chain.

14. The system of claim 13, wherein the plurality of data processing blocks comprise a main block as a first tamper-resistant block and a screen controller block as a second tamper-resistant block.

15. The system of claim 14, wherein the main block further comprises a first non-volatile storage to store the private key, and wherein the processor of the main block is a decoder configured to decode the decrypted data, and the screen controller block further comprises a screen controller and a second non-volatile memory storing a block identifier for the screen controller block.

16. An apparatus for receipt and process of encrypted data, comprising:
a receiver to receive the encrypted data, a first encryption key used for encrypting the encrypted data, and a public key of a second apparatus, wherein the first encryption key is encrypted using a public key of the apparatus;
a decryption engine to decrypt, using a private key corresponding to the public key of the apparatus, the first encryption key, and to decrypt the encrypted data using the decrypted first encryption key;
a processor to process the decrypted data;
an encryption engine to encrypt the processed data using a second encryption key, and to encrypt the second encryption key using the received public key of the block next in the chain;
a transmitter to transmit the encrypted processed data and the encrypted second encryption key to the second apparatus.

17. The apparatus of claim 16, wherein the apparatus is a block in a plurality media processing blocks connected in a chain, each first block of two adjacent blocks in the chain is configured to send the media stream in an encrypted format to a second block of the two adjacent blocks in the chain and a last block in the chain is configured to send the media stream to the screen in a non-encrypted format.

18. The apparatus of claim 16, wherein the encryption engine is further configured to:
create an initialization vector; and
send a synchronization command containing the initialization vector from the apparatus to the second apparatus.
